(19) United States
(12) Patent Application Publication
(10) Pub. No.: US 2011/0290199 A1
(43) Pub. Date: Dec. 1, 2011

(54) RESTRAINTS AND HARNESSES FOR ANIMALS

(76) Inventor: Elizabeth V. RAMIREZ, San Diego, CA (US)

(21) Appl. No.: 13/118,177

(22) Filed: May 27, 2011

Related U.S. Application Data
(60) Provisional application No. 61/349,105, filed on May 27, 2010.

(51) Int. Cl. A01K 27/00

(52) U.S. Cl. 119/792

(57) ABSTRACT

A restraint is described that may be constructed as a harness. A generally tube-shaped sleeve having a main portion has at least one hole formed therein. At least one flap extends from a first side of the main portion and attaches to a second side of the main portion. The at least one flap completes a hole that receives a leg of a wearer of the restraint. A pair of drawstrings is provided wherein each drawstring is attached to a different side of the main portion. Each drawstring can be configured to be coupled together, typically using a latching mechanism. The drawstrings adjust the fit of the restraint to the girth of the wearer of the restraint. A loop on the main portion of the harness permits fastening of a leash to the restraint.

### CROSS-REFERENCE TO RELATED APPLICATIONS

The present Application claims priority from U.S. Provisional Patent Application No. 61/349,105 filed May 27, 2010, which is expressly incorporated by reference herein for all purposes.

### BACKGROUND OF THE INVENTION

1. Field of the Invention

The present invention relates generally to restraints used to control and manage animals.

2. Description of Related Art

Existing harnesses are typically not easily adjusted for comfort and snugness of fit and require manipulation of the animal to be restrained and/or the harness during fitting.

### BRIEF SUMMARY OF THE INVENTION

Certain embodiments of the invention provide a restraint that may be constructed as a harness. The restraint may comprise a generally tube-shaped sleeve having a main portion with at least one hole formed therein. The restraint may comprise at least one flap that extends from a first side of the main portion and attaches to a second side of the main portion. The at least one flap completes a hole that receives a leg of a wearer of the restraint. In some a pair of drawstrings is provided wherein each drawstring is attached to a different side of the main portion. Each drawstring can be configured to be coupled together, typically using a latching mechanism. The drawstrings can be used to adjust the fit of the restraint to the girth of the wearer of the restraint. A loop may be provided on the main portion of the harness, typically on the back of the animal and configured to fasten a leash to the restraint. The at least one flap comprises a pair of flaps arranged on opposite sides of the leg. Some of these embodiments comprise a second pair of flaps configured to be arranged on opposite sides of another leg of the wearer. The drawstrings are typically attached to the main portion using a hook and eye fastener. The restraint may be used with dogs, cats, ferrets and other animals.

### BRIEF DESCRIPTION OF THE DRAWINGS

The figures show various examples of embodiments according to certain aspects of the invention.

FIGS. 1A, 1B and 1C provide different views of a harness according to certain aspects of the invention.

FIGS. 2A and 2B show an embodiment of the invention in fastened and unfastened states.

FIGS. 3A and 3B provide different views of a harness according to certain aspects of the invention.

FIG. 3C is a black and white image of a harness according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

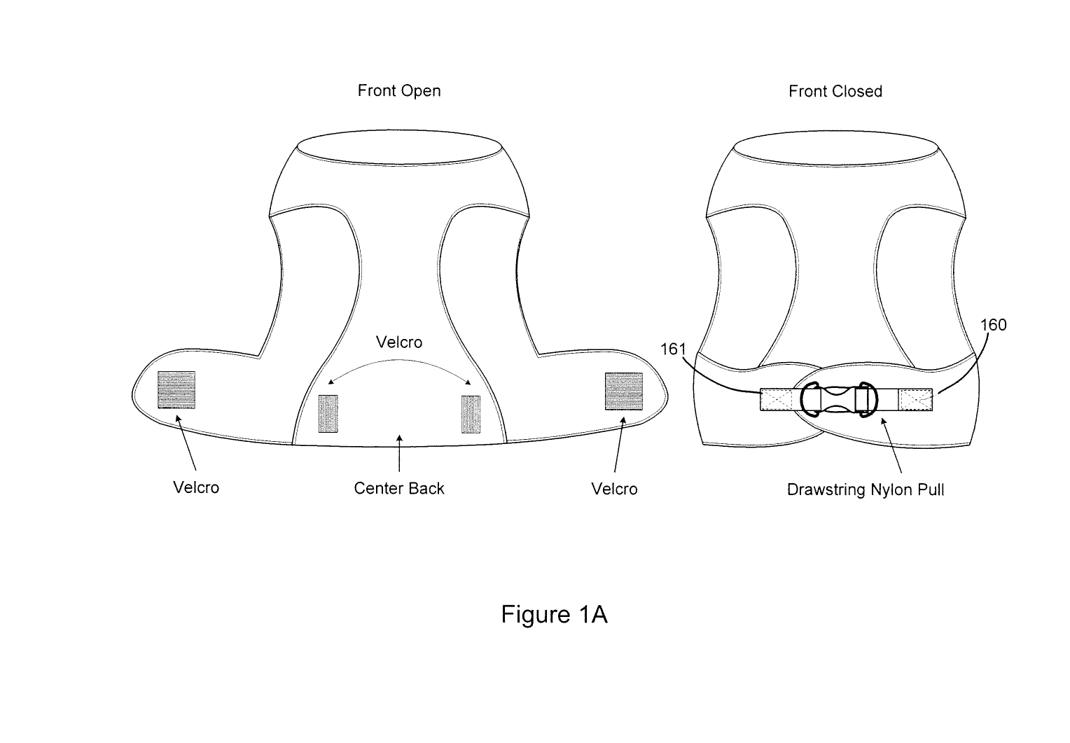

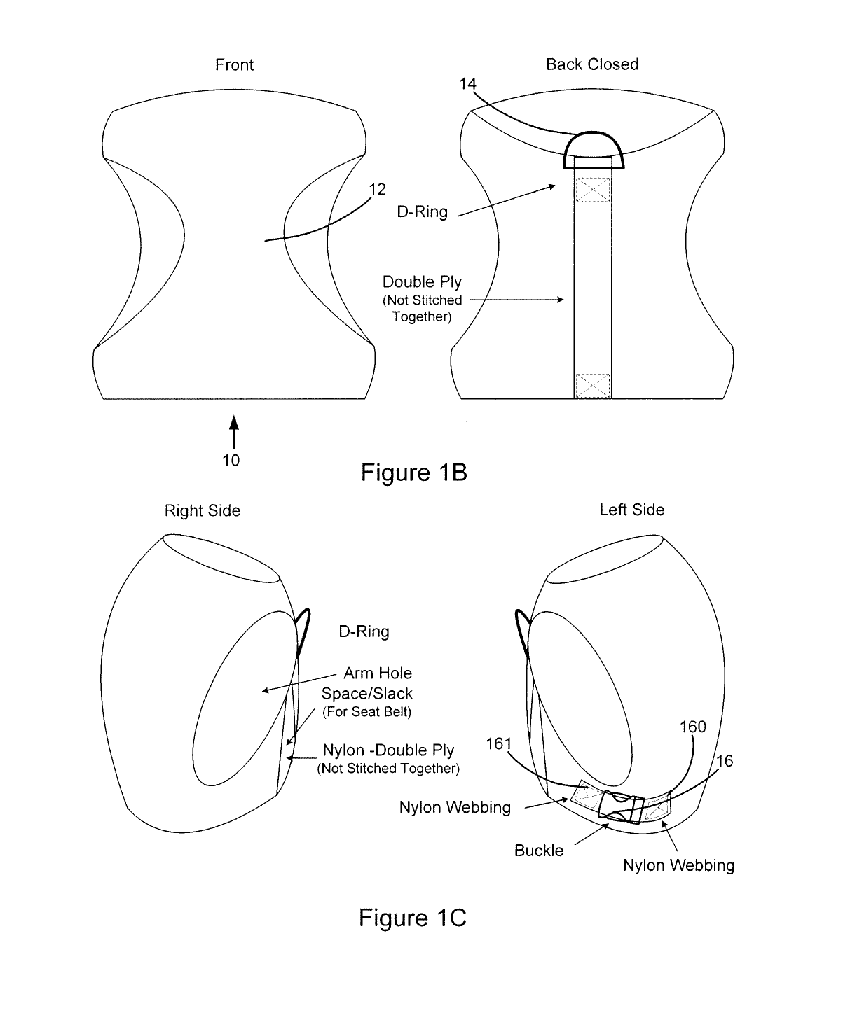

Certain embodiments of the invention comprise a harness that can be used to restrain and/or control an animal. In some embodiments, harnesses according to certain aspects of the invention can be used to restrain powerful animals while providing quick release and/or improved fit and comfort. For example, Velcro™ or other quick release bindings can be used to form the harness to the body of the wearer while certain elements of the harness are configured to withstand the force used to restrain the wearer. For example, a harness 10 (see FIGS. 1A-1C) may have a solid portion of material 12 that is worn adjacent the chest or belly of an animal wearing the harness. The chest portion 12 is coupled to a D-ring 14 or other connection for a leash without intervening Velcro™, thereby maximizing strength of the harness 10. Nylon webbing and straps 160 and 161 may be provided and buckled together using buckle 16 to assist in sizing and/or to strengthen certain bindings.

In certain embodiments a harness may be constructed such that is conforms with a body type associated with the animal and variations in scale and major dimensions may be apparent in harnesses adapted for different animal species, breeds and/or sizes of the animal. The example of a dog harness is described herein but it will be appreciated that the invention can be adapted for use with other animals such cats, ferrets, and so on.

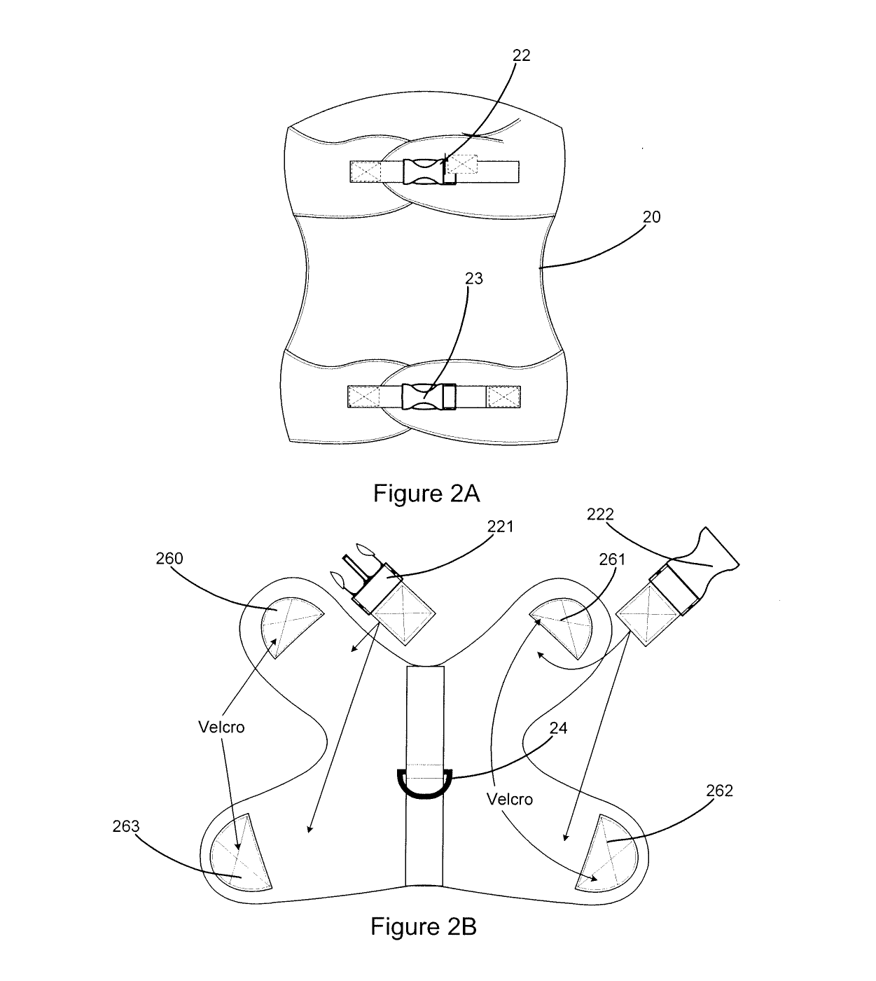

In certain embodiments, the harness may be constructed as a single component that may be opened and flattened without overlap. As shown in FIGS. 2A-2B, the harness may take a substantially “X” shape when opened and flattened, as shown in FIG. 2B. The harness can be fitted to a dog by placing the center of the “X” under the chest of the dog and subsequently folding the flaps, which form the legs of the “X”, around the body of the animal such that they intersect on the back of the animal. Fasteners 22 and 23 can be used to fasten the flaps to one another and to maintain the harness in position. In one example, hook and eye (Velcro®) fasteners 260-263 may fasten diagonally oriented flaps. It will be appreciated that the center of the “X” may be aligned with the front legs of the dog such that the flaps can be fastened to form a pair of holes surrounding the animal's legs. One or more latching mechanisms 22 and 23 may be provided on the flaps to permit tightening of the harness, to strengthen the fastening of the flaps and to carry a D-ring (not shown) or other loop or ring that can fasten a leash. In one variant (as shown in FIG. 2B), A D-ring 24 may be provided at the center of the X. In this embodiment, the legs of the X are fastened on the chest or belly of the animal. It will be appreciated that fasteners 22 and 23 will typically be expected to carry the force of restraint when a leash is connected to D-loop 24.

In the example shown in the drawings, a harness according to certain aspects of the invention can comprise a tubular body when closed, wherein the tubular body has an opening which accommodates the head and/or neck of the animal. However, certain variations are shown. As noted, the example of FIGS. 2A and 2B is generally X-shaped when opened. In the example of FIGS. 1A-1C, the harness, when opened, a pair of flaps extends from a first portion of the harness that extends away from a first side of the neck hole. The first portion and the flaps form a T-shaped section configured to wrap around the chest region of the dog such that the ends of the flaps may be attached to a second portion of the harness that extends from a second side of the neck hole opposite from the first side. The widths and lengths to the first and second portions and of the flaps are selected according to dog breed, size and weight. In use, the neck hole is slid over the head of the dog such that the first portion is aligned with the center of the dog's chest. The second portion runs along the back of the dog, and is substantially centered on and aligned with the spine of the dog. The flaps are drawn around the dog's body and attached at attachment points, typically located on the edges of the flaps. The flaps may be fastened to the attachment points using a suitable fastener such as a hook-and-eye type fastener. Drawstrings 160 and 161 attached to each flap may be latched and adjusted to maintain a tight fit of the harness to the animal. A loop may be provided on the second portion or on one or both of the drawstrings to provide an attachment point for a leash.

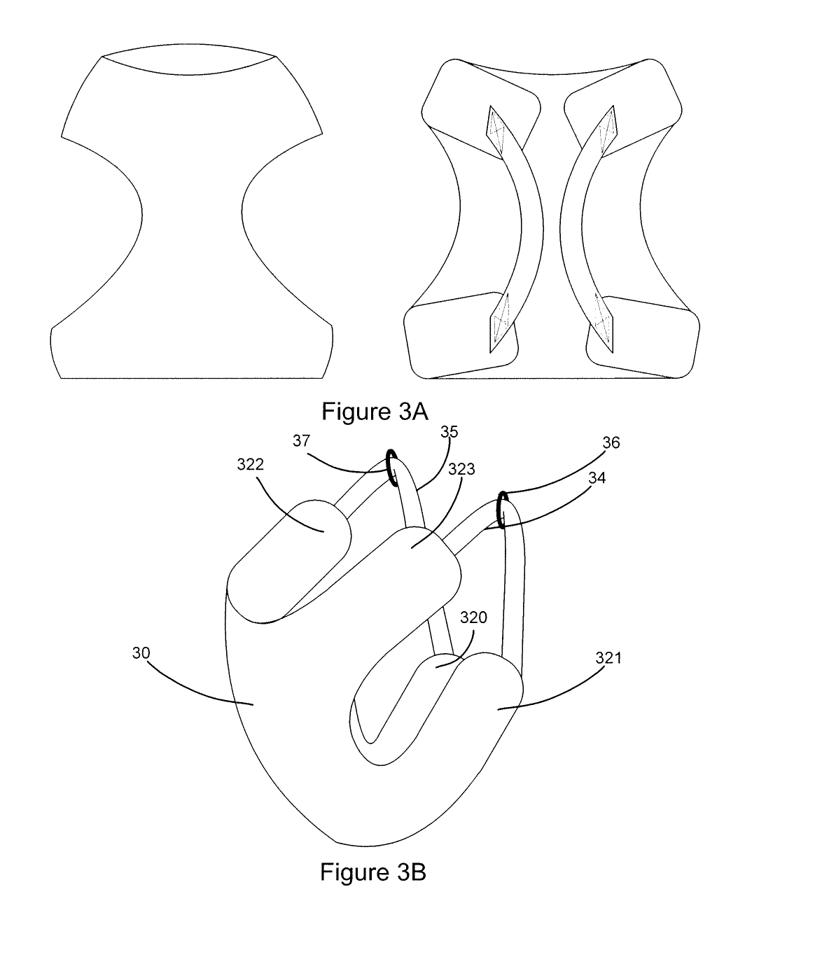

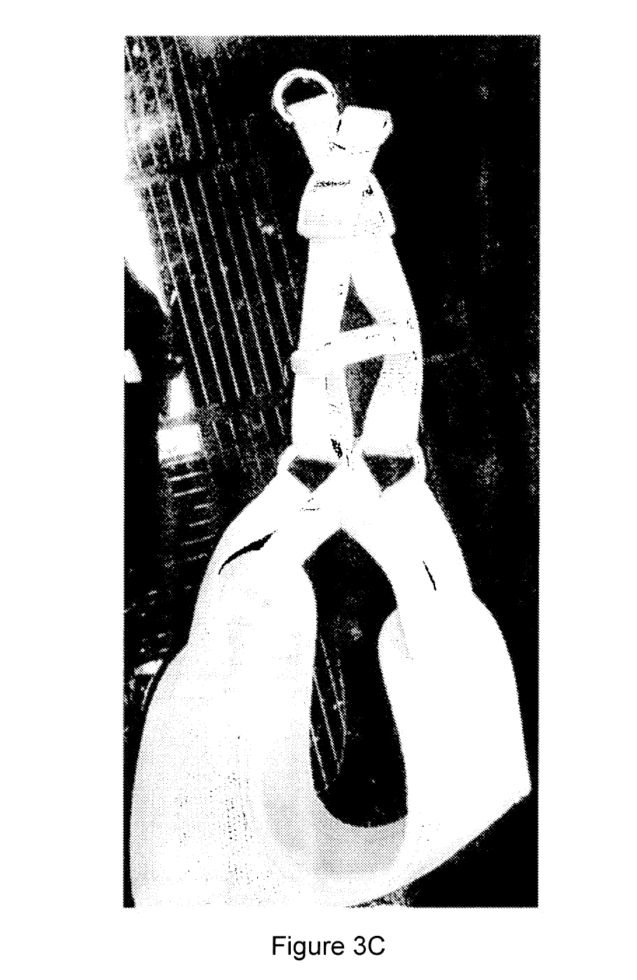

In a third example, shown in FIGS. 3A-3C, the harness may comprise a tubular body when closed, wherein the tubular body 30 has an opening created by pair of flaps 322 and 323 which accommodates the head and/or neck of the animal and a hole created by pair of flaps 320 and 321 that accommodates a body of the animal. Hook-and-eye fasteners may be used to fasten the flaps 320-323 to one another or to the body of the harness. In use, the flaps are drawn around the dog's body on either side of the second dog's leg and attached at the attachment points. The flaps 320-323 may be fastened to the attachment points using a suitable fastener such as a hook-and-eye type fastener. Drawstrings 34 and 35 may be attached to pairs of flaps, whereby rings 36, 37 may be used to receive a leash connection. Strengthening may be provided by adding straps and latches as described elsewhere herein. In some embodiments, a loop is provided directly on the harness, located above the back of the dog, to receive a leash connection.

In the examples described, the harnesses are embodied as a sleeve or substantially tube-like structure. The material used may be selected to obtain desired strength, weight and aesthetic characteristics. Multiple layers of material may be used to provide waterproofing and comfort. For example, a decorative, tough waterproof material constructed from Nylon or polyester, for example, may be used as an exterior portion while the interior of the sleeve is lined with cotton for comfort. The sleeve-like harness may additionally provide warmth and insulation for the animal.

In some embodiments, the various portions of the harness are reduced in width such that they take the form of straps around the legs and neck with lightweight materials provided along the chest of the animal. Such strap-like harnesses may be used when ambient temperature is elevated, or when the animal is being strenuously exercised. In another variation, lightweight materials for the harness can be employed when the harness is intended for use with a small animal.

In certain embodiments, an “adjustability click” is provided on the harness. Adjustability is typically provided using drawstrings that attach using a latch or other device. The drawstrings can be tightened as necessary to obtain a snug fit of the harness. The location of the drawstrings can be selected to east adjustment of fit. Typically, the drawstrings are provided on the harness top (back of the dog) or side of the harness. Accordingly, the chest girth supported by the harness may be easily changed.

Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a restraint. In some of these embodiments, the restraint is embodied in a harness. Some of these embodiments comprise a sleeve having a main portion with at least one hole formed therein. Some of these embodiments comprise at least one flap that extends from a first side of the main portion and attaches to a second side of the first portion. In some of these embodiments, the at least one flap completes a hole that receives a leg of a wearer of the restraint. Some of these embodiments comprise a pair of drawstrings. In some of these embodiments, each drawstring is attached to a different side of the main portion. In some of these embodiments, each drawstring is configured to be coupled together. In some of these embodiments, the drawstrings adjust the fit of the restraint to the girth of the wearer of the restraint. Some of these embodiments comprise a loop provided on the main portion and configured to fasten a leash to the restraint. In some of these embodiments, the at least one flap comprises a pair of flaps arranged on opposite sides of the leg. Some of these embodiments comprise a second pair of flaps configured to be arranged on opposite sides of another leg of the wearer. In some of these embodiments, the drawstrings are attached to the main portion using a hook and eye fastener. In some of these embodiments, wherein the wearer is a dog. In some of these embodiments, the wearer is a cat. In some of these embodiments, the wearer is a ferret.

Certain embodiments of the invention provide a harness. Some of these embodiments comprise a sleeve having a main portion with at least one hole formed therein. Some of these embodiments comprise at least one flap that extends from a first side of the main portion and attaches to a second side of the first portion. In some of these embodiments, the at least one flap completes a hole that receives a leg of a wearer of the harness. Some of these embodiments comprise a pair of drawstrings. In some of these embodiments, each drawstring is attached to a different side of the main portion. In some of these embodiments, each drawstring is configured to be coupled together. In some of these embodiments, the drawstrings adjust the fit of the harness to the girth of the wearer of the harness. Some of these embodiments comprise a loop provided on the main portion and configured to fasten a leash to the harness. In some of these embodiments, the at least one flap comprises a pair of flaps arranged on opposite sides of the leg. Some of these embodiments comprise a second pair of flaps configured to be arranged on opposite sides of another leg of the wearer. In some of these embodiments, the drawstrings are attached to the main portion using a hook and eye fastener. In some of these embodiments, wherein the wearer is a dog. In some of these embodiments, the wearer is a cat. In some of these embodiments, the wearer is a ferret.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A restraint comprising:
a sleeve having a main portion with at least one hole formed therein;
at least one flap that extends from a first side of the main portion and attaches to a second side of the main portion, thereby forming a hole that receives a leg of a wearer of the restraint;
a pair of straps, each attached to a different side of the main portion and configured to be coupled together, wherein the drawstrings adjust the fit of the restraint to the girth of the wearer of the restraint;
and a loop provided on the main portion and configured to fasten a leash to the restraint.

2. The restraint of claim 1, wherein the at least one flap comprises a pair of flaps arranged on opposite sides of the leg.

3. The restraint of claim 2, further comprising a second pair of flaps configured to be arranged on opposite sides of another leg of the wearer.

4. The restraint of claim 1, wherein the drawstrings are attached to the main portion using a hook and eye fastener.

5. A restraint comprising:
a body portion having two or more flaps, wherein the two or more flaps attach to one another to create a substantially tubular harness body, wherein the flaps attach to one another using a hook and eye material;
a pair of straps, each attached to a different side of the main portion and configured to be coupled together using a latch; and
a ring carried by at least one of the straps and configured to receive a leash, wherein forces applied to restrain a wearer of the restraint are resisted by the body portion, the pair of straps and the latch.
